(19) United States
(12) Patent Application Publication
(10) Pub. No.: US 2006/0268799 A1
(43) Pub. Date: Nov. 30, 2006

(54) METHOD AND APPARATUS FOR WiFi TERMINAL WITH DUAL MAC STRUCTURE THAT ENABLES SEAMLESS VOICE COMMUNICATIONS HANDOVER

(75) Inventors: William X. Huang, San Ramon, CA (US); Shanquan Bao, Alameda, CA (US); Shanghu Luo, Hangzhou (CN); Liming Gao, Alameda, CA (US); Richard Jian Chou, Shanghai (CN)

Correspondence Address: FELIX L. FISCHER, ATTORNEY AT LAW, 1607 MISSION DRIVE, SUITE 204, SOLVANG, CA, 93463, US

(73) Assignee: UTSTARCOM, INC., Alameda, CA (US)

(21) Appl. No.: 11/420,437

(22) Filed: May 25, 2006

Related U.S. Application Data
(60) Provisional application No. 60/685,153, filed on May 27, 2005.

(51) Int. Cl. H04Q 7/24

(52) U.S. Cl. 370/338

(57) ABSTRACT

A WiFi voice communication system incorporates a plurality of access points (AP) interconnected to a WiFi network. A handset for voice communication through the AP is provided with two sets of medium access control (MAC) components, each of said MAC having the capability to set up a voice or data call with an AP individually and simultaneously, and means for transferring a voice call from one AP to another by transferring from one MAC to another.

### REFERENCE TO RELATED APPLICATIONS

This application claims priority of U.S. Provisional Patent Application Ser. No. 60/685,153 filed on May 27, 2005 having the same title as the present application.

### BACKGROUND OF THE INVENTION

1. Field of the Invention

This invention relates generally to the field of telecommunications network transmission systems and, more particularly, to a network system configured to achieve seamless Wireless Fidelity (WiFi) voice and data handover via an access point incorporating dual Medium Access Control (MAC) WiFi components.

2. Description of the Related Art

Networks employing WiFi as defined in IEEE standard 802.11 wireless networking are becoming very widespread as an efficient and cost effective communication system. The use of such WiFi networds for voice transmission systems is hampered by unacceptable delay or signal loss during handoffs between access points (AP) often required during typical use of a mobile handset. Current systems attempt improvement by modification on the WiFi network side of the system; however, seamless handover is not currently possible due to the system limitations. The latest improvement on the network side as defined in IEEE Standard 802.11f only caches data in the AP to minimize data loss during handover. This approach requires hardware changes to the AP and still cannot realize seamless Voice handover, since it does not address the long search time (more than 1 second) issue on the radio interface side.

It is therefore desirable to provide a WiFi network system for voice transmission which achieves seamless handoff capability.

### SUMMARY OF THE INVENTION

The present invention is a system for WiFi voice communication which incorporates a plurality of access points (AP) interconnected to a WiFi network. A handset for voice communication through the AP is provided with two sets of medium access control (MAC) components, each of said MAC having the capability to set up a voice or data call with an AP individually and simultaneously, and means for transferring a voice call from one AP to another by transferring from one MAC to another.

WiFi voice communication seamless handoff is created by establishing a voice communication through a first AP using a first one of the MAC. Upon detecting a RSSI or BER rate drop below the pre-defined threshold levels, the second MAC is activated. The second MAC is employed to search for candidate APs within range and having RSSI and BER within limits. A second AP is selected as having the best signal and communication is established with the second AP using the second MAC. Voice communication is then transferred to the second MAC in the handset, and, the communication by the first MAC to the first AP is dropped.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the components of a network system employing the present invention;

FIG. 2 is a flow chart demonstrating the internal operation of the handset for transition between the dual MAC elements during a voice communication for seamless handoff; and,

FIG. 3 is a flow chart demonstrating the interaction of the communications network with the handset for seamless handoff.

### DETAILED DESCRIPTION OF THE INVENTION

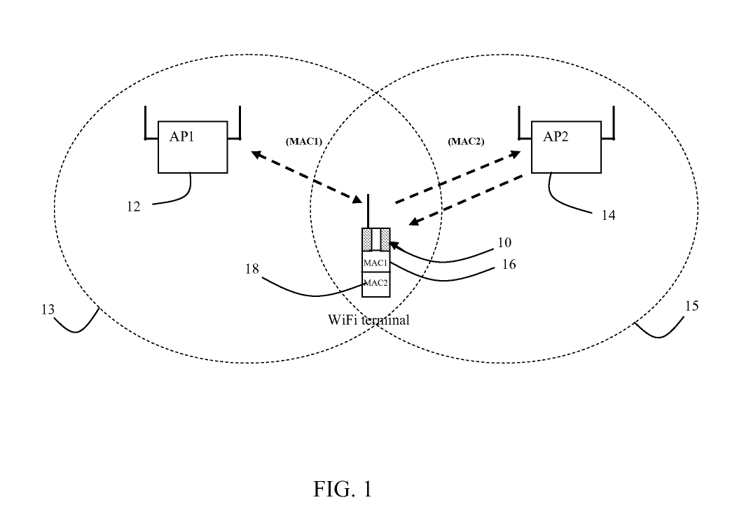

Referring to FIG. 1, a user employing a WiFi handset 10 communicates with the network through access points (AP) 12 and 14. When a user moves through a WiFi cellular communication system, it is often necessary to perform a handover of user equipment from a first AP 12 (designated AP1) located in region 13 to a second AP 14 (designated AP2) located in region 15 based on geographical requirements and loss of signal quality. In a seamless handover, a new connection of the user equipment, e.g. a handset, to the destination AP should be established before the connection to the previous AP is released. The radio interface employed in the handset usually requires more than 1 second for a single MAC WiFi terminal to search and find a candidate AP. The reason for such long search times is that the IEEE standard requires that stations must scan all available channels, (e.g. 13 possible channels in most of the European countries, 11 in the USA), and the 802.11 AP's beacon interval is set to 100 ms.

To accomplish a seamless handover, the present invention employs two MAC component sets 16 and 18 (designated MAC1 and MAC2 respectively) within the handset. Each MAC can set up a voice or data call with an AP individually and simultaneously. A seamless handover during an ongoing communication session is achieved by establishing connection with a destination AP first, then releasing connection with original AP. The WiFi terminal initiates the handover process when AP signal strength or link bit error rate (BER) rate drops below thresholds established to define desired signal quality.

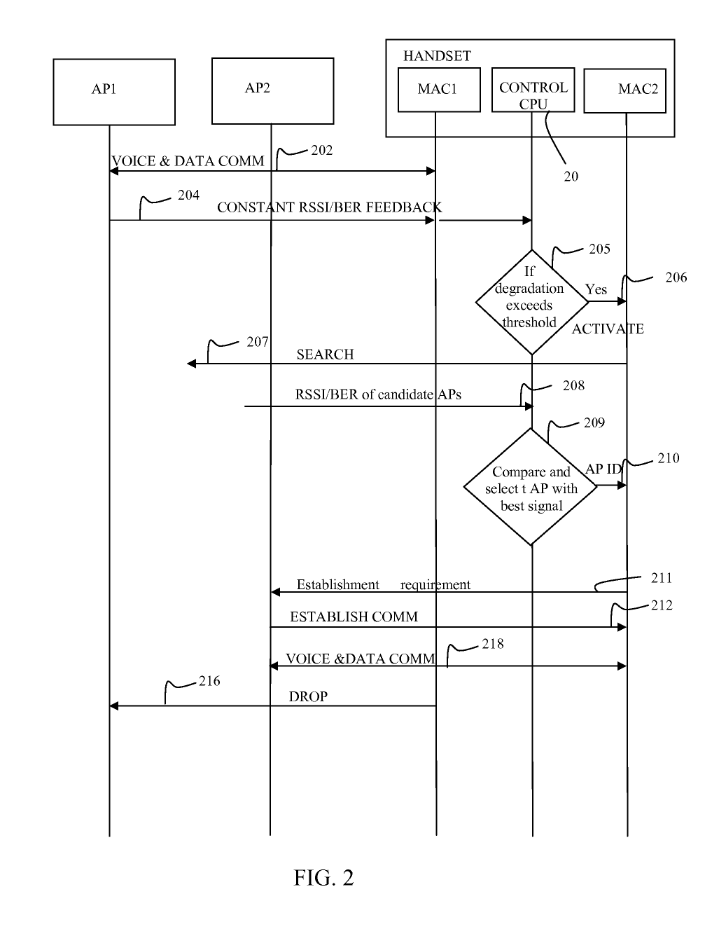

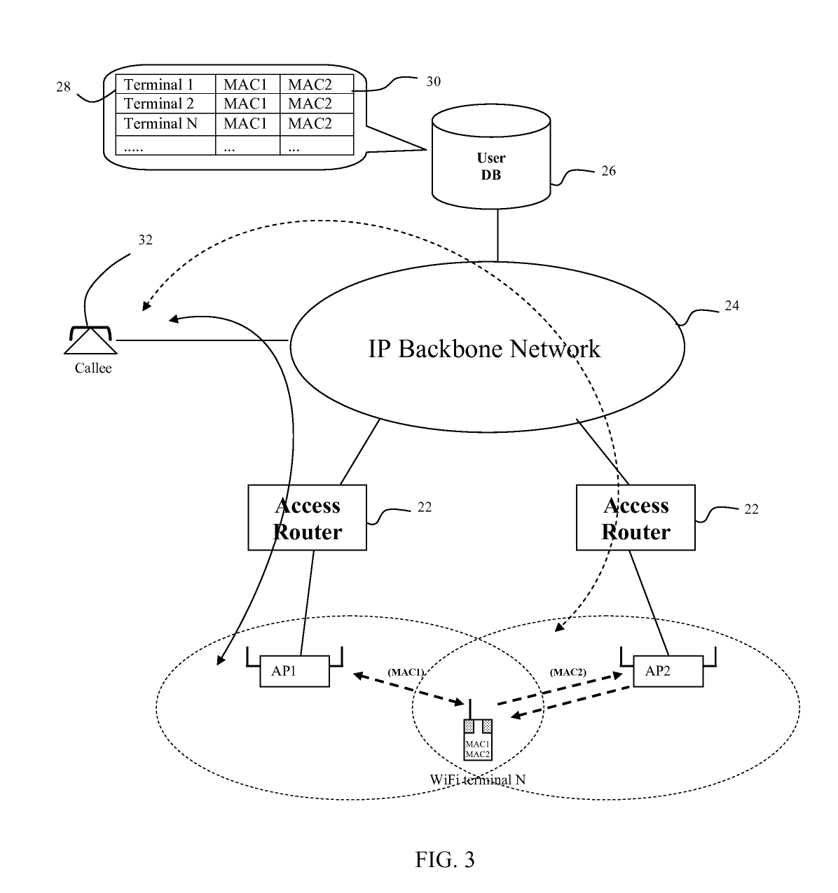

As defined in FIG. 2, the handset for a user in voice communication through AP1 is initially operating with MAC 1 202 i.e. the WiFi terminal is connected to AP1 via MAC1, to supply voice and data communications to and from the handset. As the user moves, the WiFi terminal moves. MAC1 detects RSSI or BER on a constant basis with feed back on signal quality 204 to the control CPU 20. The CPU monitors the quality and if degradation exceeds pre-defined threshold levels 205 the control CPU in the WiFi terminal activates MAC2 206. MAC2 searches for candidate APs within range 207 and candidate APs provide RSSI and BER 208. The CPU compares the quality data and selects the AP with the best signal 209. For the example shown, the terminal selects AP2 as having the best signal and forwards the address of AP2 to MAC2 210 which then solicits communication with AP2 211. Network communications through the APs is accommodated through normal Inter-Access Point Protocol (IAPP) on the network for the second party connection to the voice communication as will be described in greater detail subsequently with respect to FIG. 3. The WiFi terminal sets up connection 212 with AP2 via MAC2. The voice communication is transferred in the handset from MAC1 to MAC2. The WiFi terminal then releases the connection 216 with AP1 once the connection with the target candidate AP2 is finalized and communication is continued 218 through AP2 by MAC2, thereby accomplishing a seamless handover. .

The hardware embodiment for the invention is accomplished at the chipset level. A WiFi handset or terminal has either two separate MAC/Baseband chips to support two MAC in different chips, or in alternative embodiments, a single MAC/Baseband chip incorporating two MACs . The current WiFi terminals only have one MAC/Baseband chip, which can not support dual MAC operation.

As shown in FIG. 3, the APs operate through access routers 22 which connect to the IP backbone network 24. The network incorporates a user database 26 which registers data for individual terminals with authorized access to the system. Each terminal 28 has two MAC addresses 30 registered. Before handover is initiated, the WiFi terminal (for this example terminal N) has already established a connection to a called party 32 and is in communication through MAC1 as defined in step 202 of FIG. 2. When the WiFi terminal determines that signal quality has degraded below the defined threshold, MAC2 is activated and an AP selected as described with respect to FIG. 2. Contact with the network through AP2 and its associated access router results in the network identifying MAC2 through the user database as being associated with Terminal N. The communications stream, voice or data then being handled by the network to and from the called party and Terminal N is also streamed through AP2 to MAC2. Once the terminal determines that the MAC2 connection is established, MAC1 is turned off simultaneously. Upon release by the terminal of MAC1, the network releases the connection between MAC1 and the called party.

The ability to provide a seamless handover solution for WiFi operators resolves the key long handover time issue for WiFi network. This enables the WiFi network operator to transform the hotspot based WiFi network into a public seamless handover network, or even more a wide range mobile network to compete with traditional mobile network operators.

Having now described the invention in detail as required by the patent statutes, those skilled in the art will recognize modifications and substitutions to the specific embodiments disclosed herein. Such modifications are within the scope and intent of the present invention as summarized below.

What is claimed is:

1. A system for WiFi voice and data communication comprising:
a plurality of access points (AP) interconnected to a WiFi network;
a handset for communication through the AP, the handset having two sets of medium access control (MAC) components, each of said MAC having the capability to set up a voice or data call with an AP individually and simultaneously, and
means for transferring a voice call from one AP to another by transferring from one MAC to another.

2. A system for WiFi voice and data communication as defined in claim 1 wherein the means for transferring includes:
means for detecting a RSSI or BER rate drop below the pre-defined threshold levels, and,
means for activating the second MAC responsive to said detecting means.

3. A system for WiFi voice and data communication as defined in claim 2 further comprising:
means for searching with the second MAC for candidate APs within range and having RSSI and BER within limits; and,
means for selecting a second AP as having the best signal

4. A method for WiFi voice and data communication with seamless handoff comprising the steps of:
providing a plurality of access points (AP) interconnected to a WiFi network;
providing a handset for communication through a selected one of the plurality of APs, the handset having two sets of medium access control (MAC) components, each of said MAC having the capability to set up a voice or data call with an AP individually and simultaneously,
establishing communication through a first AP as the selected AP using a first one of the MAC,
establishing communication with the second AP as the selected AP using the second MAC,
transferring the communication to the second MAC in the handset, and,
dropping the communication by the first MAC to the first AP.

5. A method for WiFi voice and data communication with seamless handoff as defined in claim 4 further including prior to the step of establishing communication with a second AP the steps of:
detecting a RSSI or BER rate drop below the pre-defined threshold levels, activating the second MAC,
searching with the second MAC for candidate APs within range and having RSSI and BER within limits, and,
selecting a second AP as having the best signal.
